(19) United States
(12) Patent Application Publication
(10) Pub. No.: US 2009/0002263 A1
(43) Pub. Date: Jan. 1, 2009

(54) Providing a Composite Display

(75) Inventor: Davide Pasetto, Dublin (IE)

Correspondence Address: INTERNATIONAL BUSINESS MACHINES CORPORATION, IPLAW DEPARTMENT, 2455 SOUTH ROAD - MS P386, POUGHKEEPSIE, NY, 12601, US

(73) Assignee: INTERNATIONAL BUSINESS MACHINES CORPORATION, Armonk, NY (US)

(21) Appl. No.: 12/141,303

(22) Filed: Jun. 18, 2008

(30) Foreign Application Priority Data
Jun. 27, 2007 (EP) 07111136.3

(51) Int. Cl. G09G 5/00

(52) U.S. Cl. 345/1.3

(57) ABSTRACT

A composite display across multiple display means. A host computer system hosts an application capable of generating a graphics output and a plurality of rendering servers are provided, each connected to a display means for displaying a portion of the graphics output. A device driver includes means for encoding operating system primitive 2D drawing operations generated by the application on the host computer system into a wire protocol for sending to the rendering servers for execution. The rendering servers each include a graphics rendering device which renders the drawing operations in parallel with the other rendering devices.

### BACKGROUND OF THE INVENTION

This invention relates to the field of composite display solutions. In particular, it relates to implementing composite display solutions for large and distributed displays.

Many current graphical applications require very large displays in order to be used effectively. These large displays are required either to be able to see more details (rendering into a very large pixel array) and/or to be able to arrange multiple high resolution windows side by side.

The current technology of a single monitor and graphics card can scale a display resolution and size up to only a relatively small size. Several windowing systems try to overcome the hardware limitations by allowing the user to insert multiple graphics card into a single workstation to create a “multi desktop” system, allowing the movement of windows between the various desktops.

Other solutions use a very high resolution graphics card connected to a display wall which accepts a single video signal as input and scales it to a monitor wall.

A different solution is provided by DMX (Distributed Multihead X) server. The solution relies on the X protocol technology for creating a single wall tiled display, composed by a set of X display servers hosted on networked machines. The X client application connects to this special X display server and can operate as usual. Internally, the DMX server acts as a client to the X display servers that run on the rendering servers and uses Xlib commands to render into the remote displays. This solution is available on X windows only.

US published application 2002/0116539 discloses what is known as the Princeton University display wall. This display system is for Windows operating systems (Windows is a trade mark of Microsoft Corporation). The display images are generated as pixel data inside the client, then compressed as images and sent to the large display. The system is based on transforming the Window device driver interface (DDI) to remote procedure calls to remote nodes, each one in charge of rendering a subset of the display.

### SUMMARY OF THE INVENTION

One embodiment of the present invention provides a technique for developing scalable high resolution visualization systems, which span multiple monitors attached to multiple workstations connected by a high speed network.

The multiple monitors may be arranged geometrically as part of a single large composite, high resolution display.

According to a first aspect of an embodiment of the present invention there is provided a system for providing a composite display across multiple display means, comprising: a host computer system hosting an application capable of generating a graphics output; a plurality of rendering servers, each connected to a display means for displaying a portion of the graphics output, each rendering server including a graphics rendering device; and a device driver including means for encoding operating system primitive 2D drawing operations generated by the application on the host computer system into a wire protocol for sending to the rendering servers for execution.

The graphics rendering device on a rendering server preferably renders the drawing operations in parallel with the other rendering devices. A graphics rendering device may include a graphics accelerator which rasterizes the results of the drawing operations to a frame buffer.

The drawing operations may be encoded using low level encoded graphics instructions and the rendering servers may include decoding means. The drawing operations are preferably windowing system specific operations or operating system specific operations.

The device driver may include means for dividing the drawing operations into portions, each portion being for one of the graphics rendering devices. The device driver may include means for defining a rendering server drawing state for each rendering server, the rendering server drawing state including information on how the drawing operations are to be performed by the rendering server.

The device driver may include means for implementing windowing system specific accelerator rendering hooks in the graphics rendering devices.

The device driver may be connected to, coupled via a network, or integral to the host computer system.

The host computer system may also include a local display, independent and capable of displaying a different display to that of the composite display of the rendering servers.

According to a second aspect of an embodiment of the present invention there is provided a device driver comprising: means for encoding operating system primitive 2D drawing operations generated by an application into a wire protocol for sending to a plurality of rendering servers for execution; means for dividing the drawing operations into portions, different portions being sent to different rendering servers for execution.

According to a third aspect of an embodiment of the present invention there is provided a method for providing a composite display across multiple display means, comprising: encoding operating system primitive 2D drawing operations generated by an application into a wire protocol for sending to a plurality of rendering servers for execution; dividing the drawing operations into portions, different portions being sent to different rendering servers for execution in parallel.

The method may include defining a rendering server drawing state for each rendering server, the rendering server drawing state including information on how the drawing operations are to be performed by the rendering server and the state cached inside a device driver. The method may further include sending the portion of the encoded drawing operations and the rendering server drawing state to a rendering server only when needed.

Encoding drawing operations may provide an ordered stream of drawing instructions including an operation code and variable parameters for the operation. The method may include implementing windowing system specific accelerator rendering hooks in graphics rendering devices of the rendering servers.

According to a fourth aspect of an embodiment of the present invention there is provided a computer program product stored on a computer readable storage medium, comprising computer readable program code means for performing the steps of: encoding operating system primitive 2D drawing operations generated by an application into a wire protocol for sending to a plurality of rendering servers for execution; dividing the drawing operations into portions, different portions being sent to different rendering servers for execution in parallel.

An embodiment of the present invention describes a general, operating system independent, technique for implementing a large composite display which spawns distributed graphics cards hosted inside a server cluster connected by a high speed network.

An embodiment of the present invention uses a virtual device driver on the client machine which encodes the drawing operations into a wire protocol using low level encoded graphics instructions, which is sent and executed by simple rendering servers.

This enables the drawing to be performed on the tiled display rendering cluster and not in the client system. This allows higher resolution, scalability and parallel rendering.

### BRIEF DESCRIPTION OF THE DRAWINGS

Embodiments of the present invention will now be described, by way of examples only, with reference to the accompanying drawings in which:

FIG. 1 is a block diagram of a tiled display system as known in the art;

FIG. 2 is a block diagram of a system in accordance with the present invention;

FIG. 3 is a flow diagram of a method in accordance with an aspect of the present invention; and

FIG. 4 is a flow diagram of a method in accordance with another aspect of the present invention.

### DETAILED DESCRIPTION

A software application running on a data processing system conventionally sends a stream of graphics commands to a graphics rendering device installed on one of the I/O interfaces of the system. The graphics rendering device then renders the data into pixels that are stored as raster content in the video memory of the graphics rendering device and outputs them to the local display as a video signal.

For greater visualization, the raster representation of the graphics can be provided across a composite array of display devices, often referred to as a display wall. The graphics can be divided into a tiled display with each tile provided by an individual display monitor.

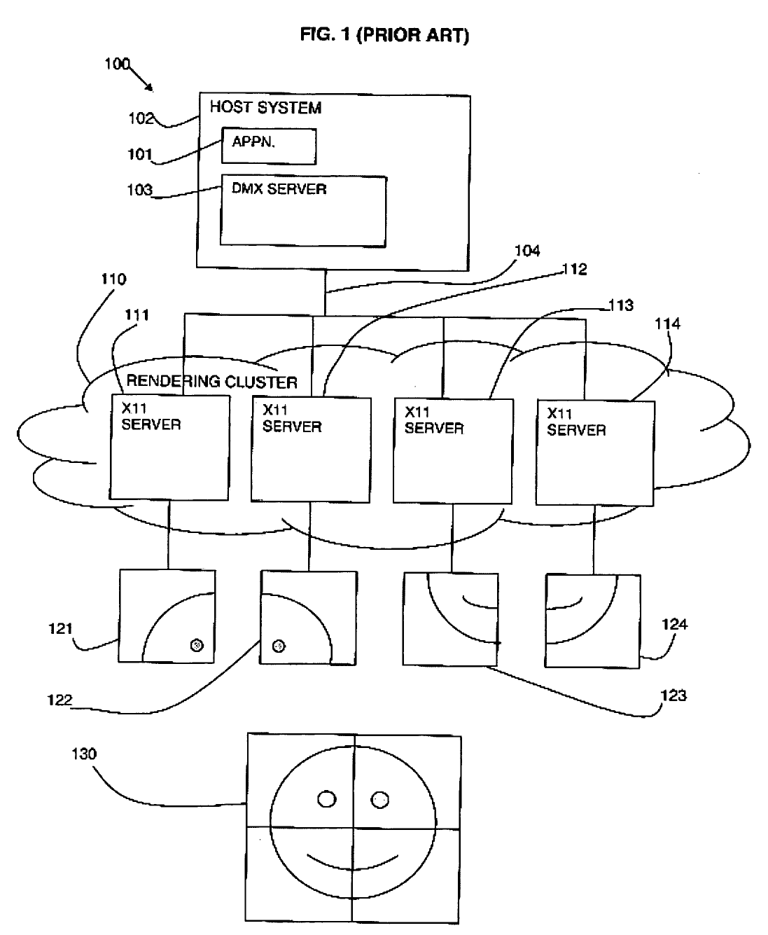

Referring to FIG. 1, a visualization system 100 as known in the prior art is shown. The visualization system 100 includes a software application 101 running on a host data processing system 102. The application 101 uses a special local display server 103 (the DMX server). The special display server 103 of the application 101 is virtualized through the use of a local network 104 (usually Ethernet) linking to a rendering cluster 110 comprising a plurality of X servers 111-114. Each of the X servers 111-114 is used to draw a portion of the graphics output on individual displays 121-124.

The special display server 103 accepts standard X11 calls make by the application 101, encodes them, and performs the same X11 function call onto each node of the cluster 110 of rendering servers 111-114. Each member of the cluster 110 receives the X11 function call data and draws its portion of the final image in parallel. Each rendering server 111-114 displays a portion 121-124 of the image. This may be, for example, as a tile of a display wall or projection system.

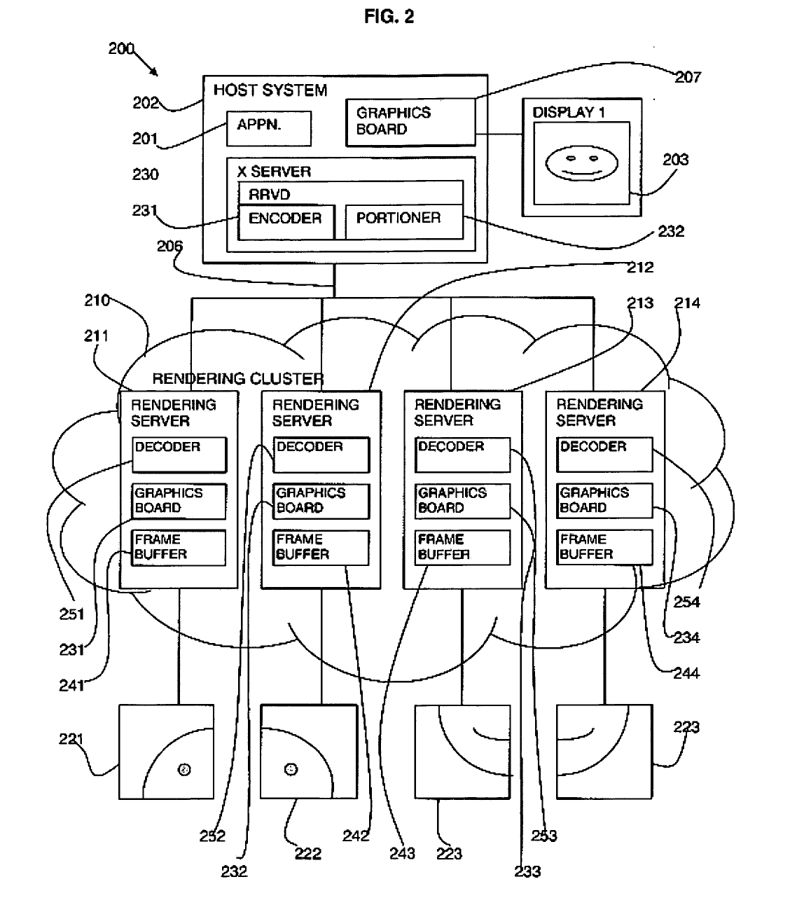

Referring to FIG. 2, a visualization system 200 is provided in accordance with the present invention. As in the prior art system 100 of FIG. 1, the system 200 includes a software application 201 running on a host data processing system 202. A local display 203 of the application 201 is provided attached to a local graphics rendering device 207 (such as a graphics processing unit (GPU), a graphics card, etc.). A second, larger and different, display is provided through the use of a high-speed local network 206 linking to a rendering cluster 210 comprising a plurality of rendering servers 211-214. Each of the rendering servers 211-214 renders a portion of the graphics output on individual displays 221-224.

The described system 200 further includes a remote video device driver (RVDD) 230, which is used by the host windowing systems, which may be standard X windows or Windows desktop. The RVDD 230 is shown on an X server 208 on the host system 202. The RVDD 230 includes an encoder 231 for encoding the drawing operations of the application 201 into a wire protocol which is sent and executed by the rendering servers 211-214. This enables the drawing operations to be performed on the rendering servers 211-214 instead of the host system 202 which allows higher resolution and scalability. The drawing operations are operating system primitive 2D drawing operations. The RVDD 230 includes a portioning means 232 for dividing the operations into portions, one for each of the rendering servers 211-214.

The RVDD 230 is an operating system specific video device driver which implements a very large display size and which implements all hardware acceleration hooks used by the host windowing systems to take advantage of underlying hardware.

The RVDD 230 may be provided on the host system 202 or on a server accessible by the host system 202 via a network. The RVDD 230 accesses the set of rendering servers 211-214 through the use of the high speed network 206.

Each rendering server 211-214 contains a decoder 251-254, one or more graphics rendering device referred to hereafter as a graphics board 231-234, a frame buffer 241-244 and is connected to a display device 221-224.

Common graphics drawing commands are sent to a graphics accelerator of the graphic board 231-234 in their raw form. The accelerator then rasterizes the results of the command to the frame buffer 241-244. Carrying out this processing at the rendering servers 211-214 can save processor capacity which would otherwise be carried out by the host system 202.

As an example embodiment, a tiled display may be formed of N×M display tiles with a total resolution of the display of W×H pixels. Each rendering server is entitled to a display tile of W/N×H/M pixels.

The RVDD 230 reports to the operating system as being connected to a special monitor type, whose capability is displaying W×H pixels. The operating system is then effectively using a W×H pixels capable virtual graphics card.

The RVDD 230 does not provide direct frame buffer access to the hosting windowing system. It instead implements all windowing system specific accelerated rendering hooks, which are used by windowing system to leverage the hardware acceleration features available on modern graphics cards.

A drawing wire protocol is defined, allowing the RVDD 230 to encode each windowing system or operating system specific operation. For example, the operations may include the Graphics Device Interface (GDI) calls of a Windows operating system, or the Direct Graphics Access (DGA) operations of an X window system. The operations are encoded into an ordered stream of basic drawing and management operations.

This stream is clipped for each display portion, thus realizing a different sub-stream directed to each different display portion. Each sub-stream is sent to the owning rendering server 211-214. The rendering servers 211-214 receive and execute the drawing operations.

The RVDD 230 integrates with the operating system features of the host system 202, such as multiple monitor support, thus allowing for example to have a small monitor connected to the host system 202 through the local graphic board 207 and a big display wall attached to the same host system 202. Windows can be drag and dropped from the small monitor to the big display wall for higher resolution and size display.

The RVDD 230 always responds positively to a probe request from the host operating system 202, thus always appearing among the installed devices.

At initialization, the RVDD 230 will read configuration parameters, which contains:
the overall tiled display pixel size (W×H);
the arrangements of the display tiles (N×M);
size (in pixel) of borders between the displays;
the list of rendering servers, complete with IP address, screen ID, position in the tile matrix.

The RVDD 230 communicates with the rendering servers 211-214 using a rendering server state and a stream of low level drawing instructions.

The rendering server state records information about how the basic drawing operations are performed. Each rendering server 211-214 has his own server state, which can be different from the other rendering servers 211-214.

Information stored on the drawing state are:

foreground pixel colour

background pixel colour

line width (in pixels)

line style (e.g. Solid, OnOffDash, DoubleDash)

cap style (e.g. NotLast, Butt, Round, Square)

join style (e.g. Miter, Round, Bevel)

clip region (list of rectangles that describe the region we can write to)

brush bitmap

tile bitmap

stipple bitmap

current font

current alpha translation table

current fill parameters

All resource allocation control will be performed by the RVDD 230, thus avoiding the need for information sent back to the host system 202 from the rendering servers 211-214.

The frame buffer 241-244 of each rendering server 211-214 will be a truecolor RGB with 8 bits per colour.

The instruction stream is composed by an ordered sequence of basic drawing instructions. Each instruction is composed of an opcode (instruction type) and a variable number of parameters; the number of parameters depends on the opcode.

The set of available instructions can be divided into the following:

1. Management of the rendering server drawing state;

2. Management of off screen buffers;

3. Pointer control;

4. Perform 2D drawing operations;

5. Perform 2D area blits;

6. Transfer images.

Each windowing system specific device driver functionality and acceleration hooks will be implemented using one or more rendering server opcodes.

The basic opcodes required for full feature RVDD implementation are defined. Coordinate and size are in display wall pixels.

The display wall allows the operating system to allocate “off screen memory”, usually present on every graphic board, to use as off screen buffers, which can be used to implement double or triple buffering surfaces or to load and blit images. Off screen images are drawn on every rendering server 211-214, thus ready for being blitted on any part of the screen.

1. Management of the rendering server drawing state:

A SET opcode is provided for each drawing state value.
These opcodes are sent to a specific rendering server 211-214 in which the rendering state is to be changed.
A cache mechanism, implemented inside the RVDD 230, minimizes the number of state change requests sent to the rendering servers 211-214.

2. Management of off screen buffers:

INITBUF bufferid width height—allocate and initialize an offscreen buffer
FREEBUF bufferid—free resources used by an offscreen buffer
These opcodes are sent to all rendering servers 211-214 and buffers are always created on all rendering nodes: a single bufferid space exists in the system.

3. Pointer control:

MOVEPOINTER x y—move the pointer to the position specified, deleting it from the last position and rendering it on the new position.
LOADPOINTER bufferid xoff yoff—change the pointer image and size to the one contained into bufferid; the offsets specify the pointer hook inside the pointer image.
The MOVEPOINTER opcode is sent to the rendering servers that intersect the rectangle for the previous and the new position of the pointer image.
The LOADPOINTER opcode is sent to all rendering servers.

4. Perform 2D drawing operations:

DRAWLINE surface x1 y1 x2 y2—draw a single line from x1, y1 to x2, y2 using the current drawing state values.
DRAWBEZIER surface bezierparams.
DRAWBEZIERFILL surface bezierparams.
DRAWELLIPSE surface ellipseparams.
DRAWELLIPSEFILL surface ellipseparams.
DRAWMULTI surface [list of lines, beziers, ellipses]
DRAWMULTIFILL surface [list of lines, beziers, ellipses]
Surface can be either the frame buffer 241-244 or any allocated off screen buffer.
These opcodes are sent to the rendering servers 211-214 that intersect the object being drawn.

5. Perform 2D area blits:

COPYAREA surffrom, surfto x y width height tox toy.
COPYBLEND surffrom surfto x y width height tox toy.
COPYSCALE surffrom surfto x y width height tox toy towidth toheight.
COPYROTATE surffrom surfto x y width height tox toy rotationparams.
CHANGEAREA (surffromid, surfto, operation, x, y, width, height, tox, toy).
CHANGESCALE (surffromid, surfto, operation, x, y, width, height, tox, toy, towidth, toheight).
CHANGEROTATE (surffromid, surfto, operation, x, y, width, height, tox, toy, rotation params).
Surface can be either the frame buffer 241-244 or any allocated off screen buffer.
These opcodes are sent to the rendering servers 211-214 that intersect the object being drawn.

6. Transfer images:

LOADIMAGE (surfaceid, format, imagedata)
Surfaceid is any allocated off screen buffer.
This opcode is sent to all rendering servers 211-214, so the image is immediately ready for being copied on any screen portion.

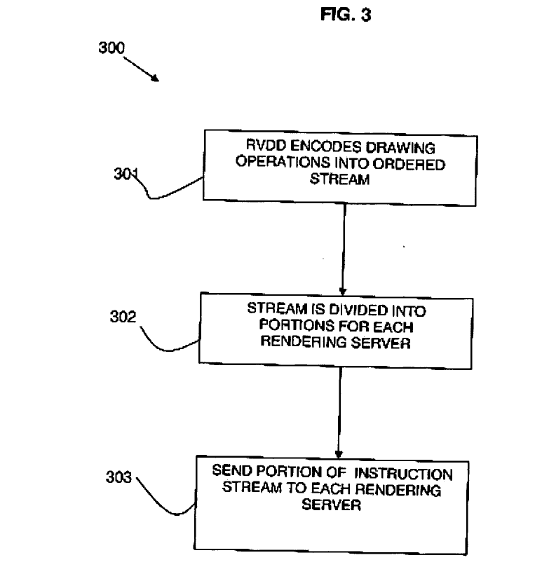

Referring to FIG. 3 a flow diagram 300 shows the method steps carried out at the RVDD 230.

The RVDD encodes drawing operations into an ordered stream 301 which is divided 302 into portions for each rendering server. The rendering server portion of the instruction stream is sent 304 to each rendering server. A rendering server drawing state for each rendering server is cached inside the RVDD, thus minimizing the send of state changes.

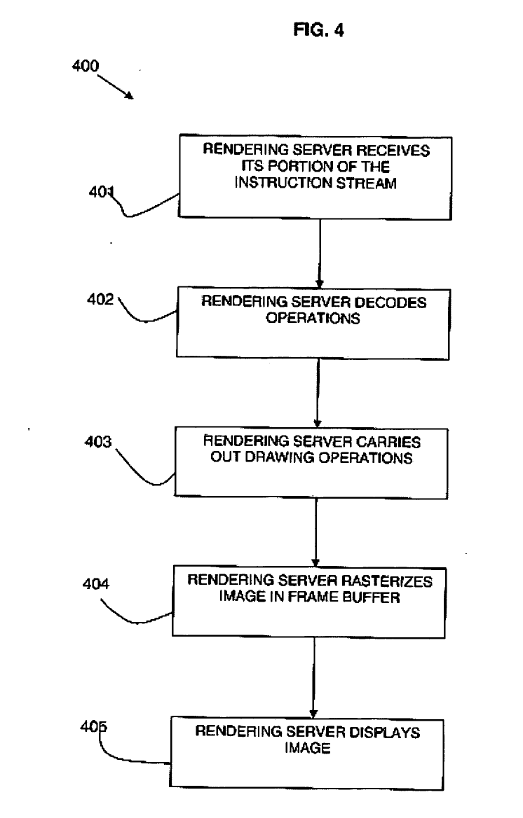

Referring to FIG. 4, a flow diagram 400 shows the method steps carried out at a rendering server.

A rendering server receives 401 the rendering server drawing state and portion of the instruction stream. The rendering server decodes 402 and carries out 403 the drawing operations. The rendering server rasterizes 404 the image in its frame buffer and displays 405 the image.

One embodiment of the invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

One embodiment of the invention can take the form of a computer program product accessible from a computer-usable or computer-readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read only memory (ROM), a rigid magnetic disk and an optical disk. Current examples of optical disks include compact disk read only memory (CD-ROM), compact disk read/write (CD-R/W), and DVD.

Improvements and modifications can be made to the foregoing without departing from the scope of the present invention.

1. A system for providing a composite display across multiple display means, the system comprising:
a host computer system hosting an application capable of generating a graphics output;
a plurality of rendering servers, each connected to a display means for displaying a portion of the graphics output, each rendering server including a graphics rendering device; and
a device driver including means for encoding operating system primitive 2D drawing operations generated by the application on the host computer system into a wire protocol for sending to the rendering servers for execution.

2. A system as claimed in claim 1, wherein the graphics rendering device on a rendering server renders the drawing operations in parallel with the other rendering devices.

3. A system as claimed in claim 1, wherein a graphics rendering device includes a graphics accelerator which rasterizes the results of the drawing operations to a frame buffer.

4. A system as claimed in claim 1, wherein the drawing operations are encoded using low level encoded graphics instructions and the rendering servers include decoding means.

5. A system as claimed in claim 1, wherein the drawing operations are windowing system specific operations or operating system specific operations.

6. A system as claimed in claim 1, wherein the device driver includes means for dividing the drawing operations into portions, each portion being for one of the graphics rendering devices.

7. A system as claimed in claim 1, wherein the device driver includes means for defining a rendering server drawing state for each rendering server, the rendering server drawing state including information on how the drawing operations are to be performed by the rendering server.

8. A system as claimed in claim 1, wherein the device driver includes means for implementing windowing system specific accelerator rendering hooks in the graphics rendering devices.

9. A system as claimed in claim 1, wherein the device driver is connected to the host computer system.

10. A system as claimed in claim 1, wherein the host computer system includes a local display, independent of the display of the rendering servers.

11. A device driver comprising:
means for encoding operating system primitive 2D drawing operations generated by an application into a wire protocol for sending to a plurality of rendering servers for execution; and
means for dividing the drawing operations into portions, different portions being sent to different rendering servers for execution.

12. A method for providing a composite display across multiple display means, the method comprising:
encoding operating system primitive 2D drawing operations generated by an application into a wire protocol for sending to a plurality of rendering servers for execution; and
dividing the drawing operations into portions, different portions being sent to different rendering servers for execution in parallel.

13. A method as claimed in claim 12, including:
defining a rendering server drawing state for each rendering server, the rendering server drawing state including information on how the drawing operations are to be performed by the rendering server and the state cached inside a device driver.

14. A method as claimed in claim 13, including:
sending the portion of the encoded drawing operations and the rendering server drawing state to a rendering server only when needed.

15. A method as claimed in claim 12, wherein encoding drawing operations provides an ordered stream of drawing instructions including an operation code and variable parameters for the operation.

16. A method as claimed in claim 12, wherein a rendering server includes a graphics rendering device with a graphics accelerator which rasterizes the results of the drawing operations to a frame buffer.

17. A method as claimed in claim 16, including implementing windowing system specific accelerator rendering hooks in the graphics rendering device.

18. A computer program product stored on a computer readable storage medium, comprising computer readable program code means for performing the steps of:
encoding operating system primitive 2D drawing operations generated by an application into a wire protocol for sending to a plurality of rendering servers for execution; and
dividing the drawing operations into portions, different portions being sent to different rendering servers for execution in parallel.
